(19) United States
(12) Patent Application Publication
(10) Pub. No.: US 2025/0172781 A1
(43) Pub. Date: May 29, 2025

(54) OPTICAL FIBER FANOUT AND METHODS OF MAKING THE SAME

(71) Applicant: CORNING INCORPORATED, CORNING, NY (US)

(72) Inventors: Kevin Wallace Bennett, Hammondsport, NY (US); Agnivo Gosai, Painted Post, NY (US); William James Miller, Horseheads, NY (US)

(21) Appl. No.: 18/952,732

(22) Filed: Nov. 19, 2024

Related U.S. Application Data
(60) Provisional application No. 63/603,373, filed on Nov. 28, 2023.

(51) Int. Cl. G02B 6/44; G02B 6/14; G02B 6/255

(52) U.S. Cl. CPC G02B 6/44715; G02B 6/14; G02B 6/2551

(57) ABSTRACT

Optical fiber fanouts include a body that tapers from a first dimension to a smaller second dimension. The body includes a plurality of optical fibers within an interior region of the body that is collectively surrounded by a bulk of the body. The plurality of optical fibers extend for a length of the body. A maximum dimension of an optical fiber of the plurality of optical fibers tapers from the first end to the second end. The bulk of the body does not extend into the interior region. Methods include inserting the plurality of optical fibers and optionally one or more spacers in a single hold in a glass cane. Methods include drawing the glass cane to form a taper in a center region of the glass cane to form a necked cane with the plurality of optical fibers positioned therein that is then divided in two.

This application claims the benefit of priority under 35 U.S.C. § 119 of U.S. Provisional Application Ser. No. 63/603,373 filed on Nov. 28, 2023, the content of which is relied upon and incorporated herein by reference in its entirety.

### TECHNICAL FIELD

The present disclosure relates to optical fiber fanouts and methods of making the same, and more particularly, to optical fiber fanouts comprising optical fibers in an interior region of a body of the optical fiber fanout and methods of making the same.

### BACKGROUND

Optical waveguides (e.g., optical fibers) can be used for communications of signals, for example, telecommunications over long distances. It is known that signal strength decreases as the length of the optical waveguide increases. In order to transmit signals over extremely long distances, it is known to amplify the signal at one or more locations over the extremely long distance, for example, using repeaters and/or line amplifiers. As demand for throughput (e.g., bandwidth) increases, it is known to use multicore fibers instead of single-mode fibers. However, the signals from multicore fibers may need to be split into a plurality of single-mode fibers for amplification. Consequently, there is a need to develop optical fiber fanout devices that can be assembled relatively simply and with low loss that convert between multicore optical fibers and a plurality of single-mode fibers and vice versa.

### SUMMARY

The present disclosure provides optical fiber fanouts and methods of making the same. The optical fiber fanout can optically couple a plurality of single-mode fibers at one end to a multicore fiber at the other end through a plurality of optical fibers in the optical fiber fanout running therebetween. The plurality of optical fibers are positioned in an interior region of the optical fiber fanout that is collectively surrounded by a bulk of a body of the optical fiber fanout without any of the bulk positioned in the interior region. A variety of arrangements of the optical fiber fanouts can be formed using the plurality of optical fibers and optionally one or more spacers in the interior region. For example, the plurality of optical fibers can be arranged in a two-dimensional array with at least two optical fibers arranged in each dimension (e.g., direction) (e.g., a 2 by 2 arrangement) with a spacer (e.g., single spacer) optionally positioned therebetween. Also, in aspects, the plurality of optical fibers can be arranged in a single line (e.g., 4 optical fibers arranged in a single line) with a plurality of optical fibers positioned around (e.g., on each side) of the single line. The dimensions and/or refractive index of the plurality of optical fibers at each end of the optical fiber fanout can enable 97.7% or more (e.g., 0.1 dB or less loss) for light transmitted therethrough from the plurality of single-mode fibers to the multicore fiber.

Methods of the present disclosure comprise inserting a bundle comprising a plurality of optical fibers and optionally one or more spacers in a single hole in a glass cane. Inserting the plurality of optical fibers in a single hole can enable a relatively simple assembly of the optical fiber fanout. For example, a relatively large single hole can facilitate registration (e.g., alignment) of the bundle with the hole and/or the inserting can be performed in a single step, which can reduce the time and/or effort associated with making an optical fiber fanout. In aspects, a maximum dimension of the bundle (e.g., collective dimension) can be substantially equal to a corresponding dimension of the single hole, which can enable a relative arrangement of the plurality of optical fibers to be maintained (e.g., locked in) throughout processing. In aspects, a cross-sectional shape of the single hole can be substantially circular or quadrilateral (e.g., substantially square), which in combination with the arrangement of the plurality of optical fibers and optionally one or more spacers in the bundle can enable a relative arrangement of the plurality of optical fibers to be maintained (e.g., locked in) throughout processing. Methods can further comprise drawing a center of the glass cane (with the bundle positioned therein), dividing the cane, and/or fusion splicing a plurality of single-mode fibers and a multicore fiber to corresponding ends of the resulting product to form the optical fiber fanout.

Some example aspects of the disclosure are described below with the understanding that any of the features of the various aspects may be used alone or in combination with one another.

Aspect 1. An optical fiber fanout comprising:
a body comprising a first end and a second end opposite the first end, the body tapers from a first dimension at the first end to a second dimension at the second end, the first dimension greater than the second dimension, the body further comprising:
a plurality of optical fibers within an interior region of the body that is collectively surrounded by a bulk of the body, the plurality of optical fibers extending from the first end to the second end, and a maximum dimension of an optical fiber of the plurality of optical fibers tapers from the first end to the second end with the maximum dimension at the first end greater than the maximum dimension at the second end; and
the bulk of the body that does not extend into the interior region;
a plurality of single-mode fibers optically coupled to the corresponding plurality of optical fibers at the first end; and
a multicore fiber optically coupled to the plurality of optical fibers at the second end.

Aspect 2. The optical fiber fanout of aspect 1, wherein a ratio of the first dimension to the second dimension is in a range from 10 to 100.

Aspect 3. The optical fiber fanout of aspect 2, wherein the ratio of the first dimension to the second dimension is in a range from 12 to 16.

Aspect 4. The optical fiber fanout of any one of aspects 1-3, wherein the optical fiber of the plurality of optical fibers is configured to transmit about 97.7% or more of light from a single-mode fiber of the plurality of single-mode fibers, through the optical fiber from the first end to the second end, and to the multicore fiber for at least one optical wavelength in a range from 1200 nanometers to 1650 nanometers.

Aspect 5. The optical fiber fanout of any one of aspects 1-4, wherein each optical fiber of the plurality of optical fibers comprises three distinct refractive index portions concentrically arranged in the following sequence from an inside going outwards: a first region, a second region, and a third region.

Aspect 6. The optical fiber fanout of aspect 5, wherein the maximum dimension of the optical fiber of the plurality of optical fibers at the first end of the body is from about 200 micrometers to about 500 micrometers.

Aspect 7. The optical fiber fanout of any one of aspects 5-6, wherein a relationship between a second refractive index of the second region n2 and a third refractive index of the third region n3 of (n2²−n3²)/(n2²+n3²) is in a range from 0.25 to 0.53.

Aspect 8. The optical fiber fanout of any one of aspects 1-4, wherein each optical fiber of the plurality of optical fibers consists of two distinct refractive index portions concentrically arranged with a first region surrounded by a second region.

Aspect 9. The optical fiber fanout of aspect 8, wherein the maximum dimension of the optical fiber of the plurality of optical fibers is from about 60 micrometers to about 160 micrometers.

Aspect 10. The optical fiber fanout of any one of aspects 8-9, wherein a relationship between a second refractive index of the second region n2 and a third refractive index of the body of (n2²−n3²)/(n2²+n3²) is in a range from 0.21 to 0.53.

Aspect 11. The optical fiber fanout of any one of claims 1-10, wherein the maximum dimension of the optical fiber at the second end of the body is from 8.98 micrometers to 12.22 micrometers.

Aspect 12. The optical fiber fanout of any one of aspects 1-11, wherein the plurality of optical fibers are arranged in a two-dimensional array with at least two optical fibers of the plurality of optical fibers in each dimension of the two-dimensional array.

Aspect 13. The optical fiber fanout of any one of aspect 12, wherein the two-dimensional array consists of 4 optical fibers of the plurality of optical fibers in a 2 by 2 arrangement.

Aspect 14. The optical fiber fanout of any one of aspects 12-13, wherein the interior consists of the plurality of optical fibers.

Aspect 15. The optical fiber fanout of any one of aspects 12-13, wherein the interior consists of the plurality of optical fibers and one or more spacers positioned therebetween.

Aspect 16. The optical fiber fanout of any one of aspects 1-11, wherein the plurality of optical fibers are arranged in a single line.

Aspect 17. The optical fiber fanout of aspect 16, wherein the plurality of optical fibers consists of 4 optical fibers.

Aspect 18. The optical fiber fanout of any one of aspects 16-17, wherein the interior consists of the plurality of optical fibers and a plurality of spacers.

Aspect 19. The optical fiber fanout of aspect 18, wherein the plurality of spacers are positioned on either side of the plurality of optical fibers around the single line.

Aspect 20. A method of forming an optical fiber fanout comprising:
inserting a plurality of optical fibers and optionally one or more spacers in a single hole in a glass cane; then
drawing a center of the glass cane to form a taper in a central portion of the glass cane to form a necked cane with the plurality of optical fibers positioned therein;
dividing the necked cane at a middle of the taper to form a body with a first end corresponding to an untapered end of the body and a second end opposite the first end at a tapered end of the body;
fusion splicing a multicore fiber at the second end of the body positioned to be optically coupled to the plurality of optical fibers; and
fusion splicing a plurality of single-mode fibers at the first end of the body positioned to be optically coupled to a corresponding optical fiber of the plurality of optical fibers.

Aspect 21. The method of aspect 20, wherein the plurality of optical fibers and optionally one or more spacers are arranged to have a first maximum cross-sectional dimension, and the first maximum cross-sectional dimension is substantially equal to a corresponding cross-sectional dimension of the single hole in the glass cane.

Aspect 22. The method of any one of aspects 20-21, wherein a ratio of a first dimension at the first end to a second dimension at the second end is in a range from 10 to 100.

Aspect 23. The method of any one of aspects 20-22, wherein a cross-sectional shape of the single hole is quadrilateral.

Aspect 24. The method of aspect 23, wherein the cross-sectional shape of the single hole is substantially square.

Aspect 25. The method of any one of aspects 23-24, wherein the plurality of optical fibers are arranged in a two-dimensional array with at least two optical fibers of the plurality of optical fibers in each dimension of the two-dimensional array.

Aspect 26. The method of aspect 25, wherein the two-dimensional array consists of 4 optical fibers of the plurality of optical fibers in a 2 by 2 arrangement.

Aspect 27. The method of any one of aspects 23-26, wherein no spacers are inserted in the single hole.

Aspect 28. The method of any one of aspects 23-26, wherein one or more spacers are inserted in the single hole.

Aspect 29. The method of any one of aspects 20-22, wherein a cross-sectional shape of the single hole is substantially circular.

Aspect 30. The method of aspect 29, wherein the plurality of optical fibers are arranged in a single line.

Aspect 31. The method of aspect 30, wherein the plurality of optical fibers consists of 4 optical fibers.

Aspect 32. The method of any one of aspects 30-31, wherein a plurality of spacers are inserted in the single hole, the plurality of spacers positioned around the single line.

Aspect 33. The method of any one of aspects 20-33, wherein the optical fiber of the plurality of optical fibers is configured to transmit about 97.7% or more of light from a single-mode fiber of the plurality of single-mode fibers, through the optical fiber from the first end to the second end, and to the multicore fiber for at least one optical wavelength in a range from 1200 nanometers to 1650 nanometers.

Aspect 34. The method of any one of aspects 20-33, wherein each optical fiber of the plurality of optical fibers comprises three distinct refractive index portions concentrically arranged in the following sequence from an inside going outwards: a first region, a second region, and a third region.

Aspect 35. The method of aspect 34, wherein a maximum dimension of the optical fiber of the plurality of optical fibers at the first end of the body is from about 200 micrometers to about 500 micrometers.

Aspect 36. The method of any one of aspects 34-35, wherein a relationship between a second refractive index of the second region n2 and a third refractive index of the third region n3 of (n2²−n3²)/(n2²+n3²) is in a range from 0.25 to 0.53.

Aspect 37. The method of any one of aspects 20-33, wherein each optical fiber of the plurality of optical fibers consists of two distinct refractive index portions concentrically arranged with a first region surrounded by a second region.

Aspect 38. The method of aspect 37, wherein a maximum dimension of the optical fiber of the plurality of optical fibers is from about 60 micrometers to about 160 micrometers.

Aspect 39. The method of any one of aspects 37-38, wherein a relationship between a second refractive index of the second region n2 and a third refractive index of the body of (n2²−n3²)/(n2²+n3²) is in a range from 0.21 to 0.53.

Aspect 40. The method of any one of aspects 20-39, wherein a maximum dimension of the optical fiber at the second end of the body is from 8.98 micrometers to 12.22 micrometers.

### BRIEF DESCRIPTION OF THE DRAWINGS

The above and other features and advantages of aspects of the present disclosure are better understood when the following detailed description is read with reference to the accompanying drawings, in which:

FIG. 1 schematically illustrates an optical fiber fanout in accordance with aspects of the present disclosure;

FIG. 2 is a cross-sectional view taken along line 2-2 of FIG. 1 showing a plurality of single-mode fibers in accordance with aspects of the present disclosure;

FIG. 3 is a cross-sectional view taken along line 3-3 of FIG. 1 showing a multicore fiber;

FIG. 4 is a cross-sectional view taken along line 4-4 of FIG. 1 showing a plurality of three-index optical fibers arranged in a two-dimensional array with a spacer positioned therebetween and positioned in a circularly shaped interior cross-section;

FIG. 5 is an alternative cross-sectional view taken along line 4-4 of FIG. 1 showing a plurality of three-index optical fibers arranged in a two-dimensional array without a spacer positioned therebetween and positioned in a circularly shaped interior cross-section;

FIG. 6 is an alternative cross-sectional view taken along line 4-4 of FIG. 1 showing a plurality of three-index optical fibers arranged in a two-dimensional array with a spacer positioned therebetween and positioned in a quadrilateral (e.g., square) shaped interior cross-section;

FIG. 7 is an alternative cross-sectional view taken along line 4-4 of FIG. 1 showing a plurality of two-index optical fibers arranged in a two-dimensional array with a spacer positioned therebetween and positioned in a quadrilateral (e.g., square) shaped interior cross-section;

FIG. 8 is another cross-sectional view taken along line 4-4 of FIG. 1 showing a plurality of optical fibers arranged in a single line with spacers positioned around the single line and positioned in a circularly shaped interior cross-section;

FIG. 9 is another cross-sectional view taken along line 4-4 of FIG. 1 showing a plurality of optical fibers arranged in a single line with spacers positioned around the single line and positioned in a quadrilateral (e.g., square) shaped interior cross-section;

FIG. 10 is a cross-sectional view taken along line 10-10 of FIG. 1 at a second end of the body showing a plurality of optical fibers arranged in a two-dimensional array with a spacer positioned therebetween;

FIG. 11 is another cross-sectional view taken along line 10-10 of FIG. 1 at a second end of the body a plurality of three-index optical fibers arranged in a two-dimensional array without a spacer positioned therebetween;

FIG. 12 is another cross-sectional view taken along line 10-10 of FIG. 1 at a second end of the body showing a plurality of optical fibers arranged in a single line;

FIG. 13 is another cross-sectional view taken along line 10-10 of FIG. 1 at a second end of the body showing a plurality of optical fibers arranged in a single line;

FIG. 14 schematically illustrates a glass cane with a single hole having a circular cross-sectional shape;

FIG. 15 schematically illustrates a glass cane with a single hole having a quadrilateral (e.g., square) cross-sectional shape;

FIG. 16 schematically illustrates inserting a plurality of optical fibers arranged in a two-dimensional array without a spacer into the single hole in the glass cane;

FIG. 17 schematically illustrates inserting a plurality of optical fibers arranged in a two-dimensional array with a spacer into the single hole in the glass cane;

FIG. 18 schematically illustrates inserting a plurality of optical fibers arranged in a single line with spacers arranged around the single line into the single hole in the glass cane;

FIG. 19 schematically illustrates inserting a plurality of optical fibers arranged in a single line with spacers around the single line into the single hole in the glass cane;

FIG. 20 schematically illustrates drawing a center of the glass cane and then dividing the resulting necked can with the plurality of optical fibers positioned therein;

FIG. 21 schematically illustrates a cross-sectional view of a working example in accordance with aspects of the present disclosure corresponding to a first end of the body with 250× magnification;

FIG. 22 schematically illustrates a cross-sectional view of a working example in accordance with aspects of the present disclosure corresponding to a midpoint between the first end and the second end of the body with 500× magnification; and

FIG. 23 schematically illustrates a cross-sectional view of a working example in accordance with aspects of the present disclosure corresponding to a second end of the body with 1500× magnification.

### DETAILED DESCRIPTION

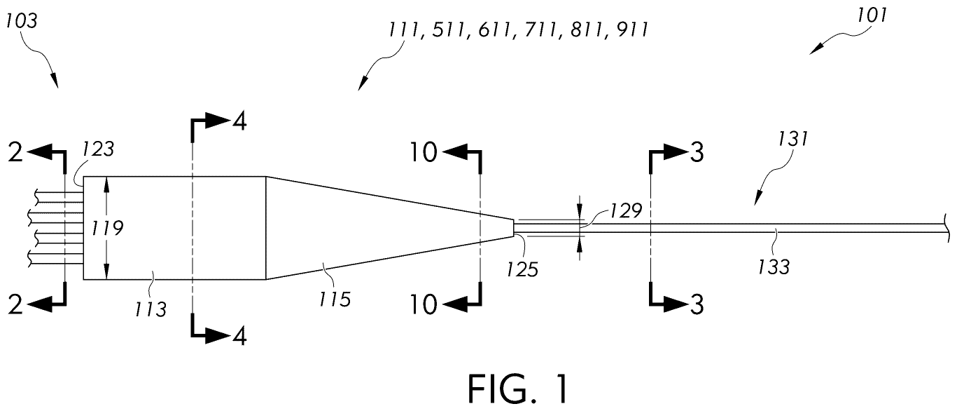

As shown in FIG. 1, an optical fiber fanout 101 optically couples a plurality of single-mode fibers 103 at a first end 123 of a body 111, 511, 611, 711, 811, or 901 to a multicore fiber 131 at a second end 125 of the body 111, 511, 611, 711, 811, or 901 (or vice versa). Unless otherwise noted, a discussion of features of aspects of one optical fiber fanout or methods of making optical fiber fanouts can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure. It is to be understood that the drawings are not necessarily to scale in order to better illustrate the aspects of the disclosure and the interaction between different components illustrated therein.

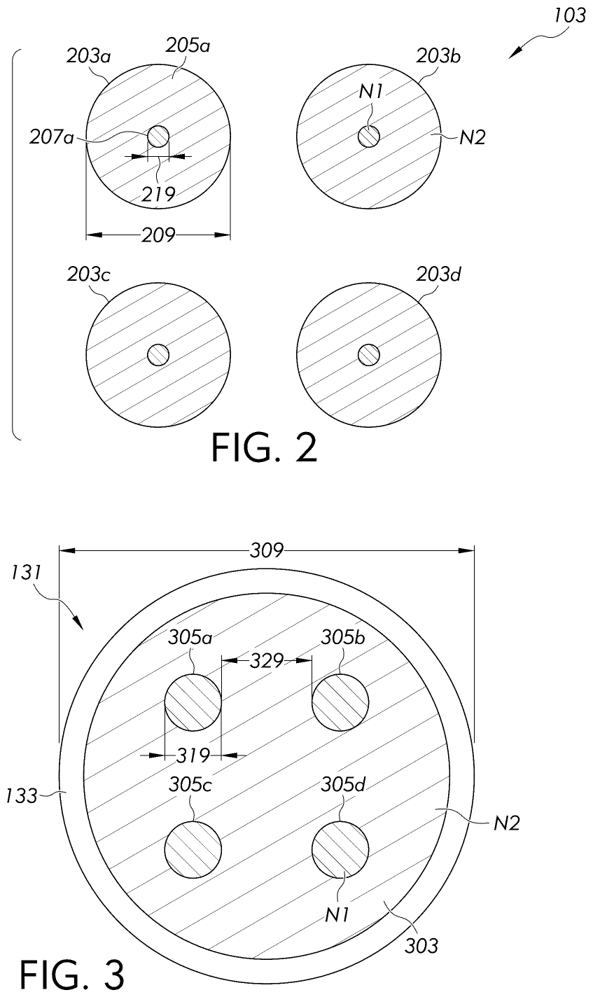

As shown in FIGS. 1-2, the optical fiber fanout 101 can comprise a plurality of single-mode fibers 103 that can be fusion spliced to the first end 123 of the body 111, 511, 611, 711, 811, or 901. In aspects, as shown, the plurality of single-mode fibers 103 can comprise four single-mode fibers 203a-203d, although any number of single-mode fibers can be provided (e.g., from 4 to 8, from 4 to 6, from 4 to 5) to be equal to a number of the plurality of optical fibers in the body 111, 511, 611, 711, 811, or 901. Each of the plurality of single-mode fibers 203a-203d can be optically coupled (e.g., fusion spliced) to a corresponding optical fiber of the plurality of optical fibers in the body 111, 511, 611, 711, 811, or 901. In aspects, as shown in FIG. 2, the single-mode fibers 203a-203b can comprise a core 207a comprising a first refractive index n1 surrounded by (e.g., circumferentially) by a cladding 205a comprising a second refractive index n2. To facilitate confinement of light configured to propagate along the core 207a (e.g., along an axis extending into the page in the view shown in FIG. 2), the second refractive index n2 can be less than the first refractive index n1. In aspects, the core 207a can comprise a substantially circular (or disk-like) cross-sectional shape (e.g., perpendicular to a propagation axis or in the cross-section shown in FIG. 2), and/or the cladding 205a can comprise a substantially circular (or annular) cross-sectional shape (e.g., perpendicular to a propagation axis or in the cross-section shown in FIG. 2). Although not shown, in further aspects, a core of the plurality of single-mode fibers can comprise another refractive index circumferentially surrounded by the first refractive index n1. In aspects, a maximum dimension 219 (e.g., perpendicular to a propagation axis or in the cross-section shown in FIG. 2) of the core 207a can be about 8 μm or more, about 9 μm or more, about 9.5 μm or more, about 10 μm or more, about 12 μm or less, about 11 μm or less, about 10.5 μm or less, or about 10 μm or less. In aspects, a maximum dimension 219 of the core 207a can be in a range from about 8 μm to about 12 μm, from about 9 μm to about 11 μm, from about 9.5 μm to about 10.5 μm, from about 9.5 μm to about 10 μm, or any range or subrange therebetween, although other ranges can be provided in other aspects. In aspects, a maximum dimension 209 (e.g., perpendicular to a propagation axis or in the cross-section shown in FIG. 2) of the cladding 205a can be about 120 μm or more, about 122 μm or more, about 124 μm or more, about 124.5 um or more, about 125 μm or more, about 130 μm or more, about 128 μm or less, about 126 μm or less, about 125.5 μm or less, about 125 μm or less. In aspects, a maximum dimension 209 of the cladding 205a can be in a range from about 120 μm to about 130 μm, from about 122 μm to about 128 μm, from about 124 μm to about 126 μm, from about 124.4 μm to about 125.5 μm, from about 124.5 μm to about 125 μm, or any range or subrange therebetween, although other ranges can be provided in other aspects.

As shown in FIGS. 1 and 3, the optical fiber fanout 101 can comprise the multicore fiber 131 spliced (e.g., fusion spliced) to the second end 125 of the body 111, 511, 611, 711, 811, or 901. In aspects, as shown, the multicore fiber 131 can a plurality of cores (e.g., four cores 305a-305d) within a body 133 of the multicore fiber 131. In aspects, as shown, the plurality of cores 305a-305d can comprise four cores, although any number of cores can be provided (e.g., from 4 to 8, from 4 to 6, from 4 to 5) to be equal to a number of the plurality of optical fibers in the body 111, 511, 611, 711, 811, or 901. In further aspects, the plurality of cores (e.g., cores 305a-305d) can comprise a first refractive index n1, a bulk 303 of the multicore fiber 131 can comprise a second refractive index n2, and the second refractive index n2 can be less than the first refractive index, for example n1, to promote confinement and/or propagation of light travelling along a corresponding core. Although not shown, in further aspects, a core of the plurality of cores can comprise another refractive index circumferentially surrounded by the first refractive index n1. In aspects, a core of the plurality of cores 305a-305d can comprise a substantially circular (or disk-like) cross-sectional shape (e.g., perpendicular to a propagation axis or in the cross-section shown in FIG. 3), the body 133 and/or the bulk 303 (excluding the plurality of cores 305a-305d) can comprise a substantially circular (or disk-like) cross-sectional shape (e.g., perpendicular to a propagation axis or in the cross-section shown in FIG. 3). In aspects, as shown, the body 133 can be a barrier layer surrounding the bulk 303, although the body can include the bulk as a homogenous region in other aspects. In aspects, as shown, a core 305a of the plurality of cores 305a-305d can comprise a maximum dimension 319 (e.g., perpendicular to a propagation axis or in the cross-section shown in FIG. 3), which can be within one or more of the corresponding ranges discussed above for the maximum dimension 219, although other ranges can be provided in other aspects. In aspects, as shown, the body 133 and/or the bulk 303 of the multicore fiber 131 can comprise a maximum dimension 309, which can be within one or more of the ranges discussed above for the maximum dimension 209, although other ranges can be provided in other aspects. In aspects, as shown, a minimum distance 329 between an adjacent pair of cores (e.g., cores 305a and 305b) can be at least one or more the lower bounds for the maximum dimension 219 and/or 319 or about 15 μm or more, about 20 μm or more, about 30 μm or more, about 40 μm or more, about 100 μm or less, about 80 μm or less, about 70 μm or less, about 60 μm or less, or about 50 um or less, for example, in a range from about 15 μm to about 100 μm, from about 20 μm to about 80 μm, from about 30 μm to about 70 μm, from about 40 μm to about 50 μm, or any range or subrange therebetween. Providing the minimum distance 329 within one or more of the ranges discussed in the previous sentence can minimize (e.g., prevent) interference and/or coupling between light propagating in an adjacent pair of cores.

As shown in FIG. 1, the body 111, 511, 611, 711, 811, or 901 can comprise barrel region 113 and a taper region 115. For example, a maximum dimension 119 at the first end 123 of the body 111, 511, 611, 711, 811, or 901 can correspond to a maximum dimension of the barrel region, and/or a maximum dimension of the barrel region 113 can be substantially constant along a corresponding length (e.g., along a propagation axis or perpendicular, perpendicular to the cross-sections shown in FIGS. 2-13, and/or perpendicular to a direction or plane in which that the maximum dimension is measured). Also, in aspects, a maximum dimension 129 at the second end 125 of the body 111, 511, 611, 711, 811, or 901 can correspond to a dimension at a smaller end of the taper region 115. As shown, the body 111, 511, 611, 711, 811, or 901 and/or the taper region 115 can taper from a maximum dimension 119 (e.g., at the first end 123 and/or at a juncture between the barrel region 113 and the barrel region 113) to a maximum dimension 129 at the second end 125, where the maximum dimension 119 is greater than the maximum dimension 129. In aspects, a ratio of the first dimension (e.g., maximum dimension 119) of the body 111, 511, 611, 711, 811, or 901 and/or the taper region 115 can to the second dimension (e.g., maximum dimension 129) of the body 111, 511, 611, 711, 811, or 901 and/or the taper region 115 can be about 10 or more, about 11 or more, about 12 or more, about 13 or more, about 14 or more, about 14.2 or more, about 14.4 or more, about 100 or less, about 50 or less, about 30 or less, about 20 or less, about 16 or less, about 15 or less, about 14.8 or less, or about 14.6 or less. In aspects, a ratio of the first dimension (e.g., maximum dimension 119) of the body 111, 511, 611, 711, 811, or 901 and/or the taper region 115 can to the second dimension (e.g., maximum dimension 129) of the body 111, 511, 611, 711, 811, or 901 and/or the taper region 115 can be in a range from about 10 to about 100, from about 10 to about 50, from about 11 to about 30, from about 11 to about 20, from about 12 to about 16, from about 13 to about 15, from about 14 to about 14.8, from about 14.2 to about 14.6, from about 14.4 to about 14.6, or any range or subrange therebetween.

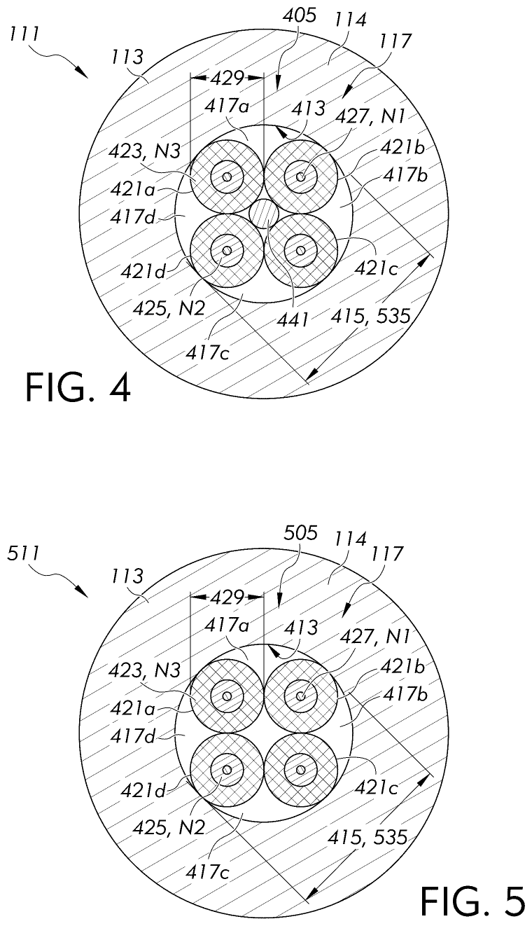

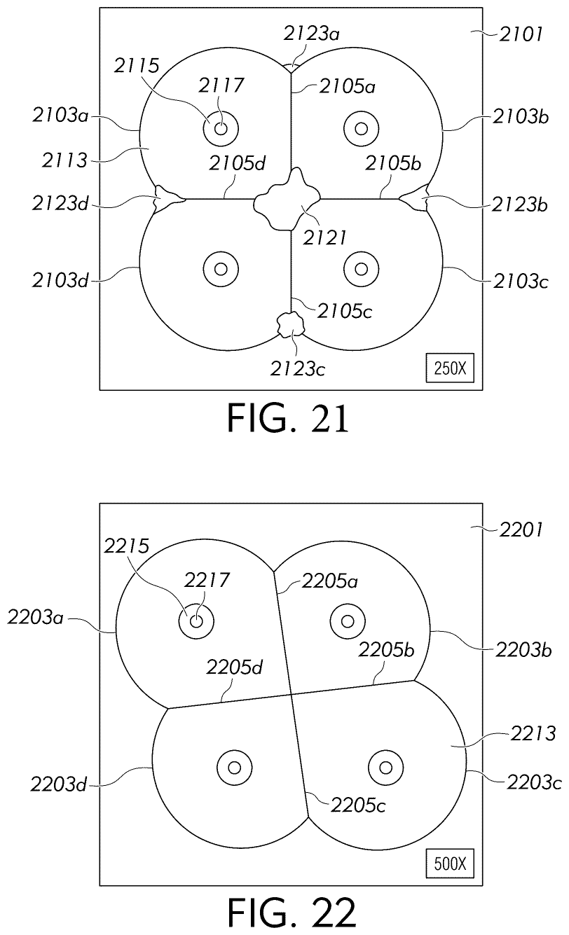

FIGS. 4-9 schematically show cross-sectional views taken along line 4-4 in accordance with various aspects that will be discussed herein. FIGS. 4-9 are intended to correspond to cross-sectional views at or near the first end 123 of the body 111, 511, 611, 711, 811, or 901. However, the elements are shown in a non-coalesced relationship (e.g., compare to FIGS. 21-23) in order to more clearly illustrate the elements and relationships therebetween. Once coalesced in accordance with the drawing process in methods of making the optical fiber fanout, the arrangement of the plurality of optical fibers, the presence of any spacers, and the lack of bulk of the body in an interior region (discussed below) can still be readily ascertained (as will be discussed more with reference to FIGS. 21-23 below). As shown in FIGS. 4-9, the body 111, 511, 611, 711, 811, or 901 includes a bulk 114 surrounds (e.g., circumferentially surrounds) but does not extend into an interior region 117, 607, or 807. Consequently, even when the materials have coalesced during drawing, the absence of the bulk 114 between the plurality of optical fibers 405, 505, 605, 705, 805, and/or 905 and/or the presence of residual air gaps between the optical fibers and the bulk 114 can be observed as a tell-tale sign of the aspects of the present disclosure.

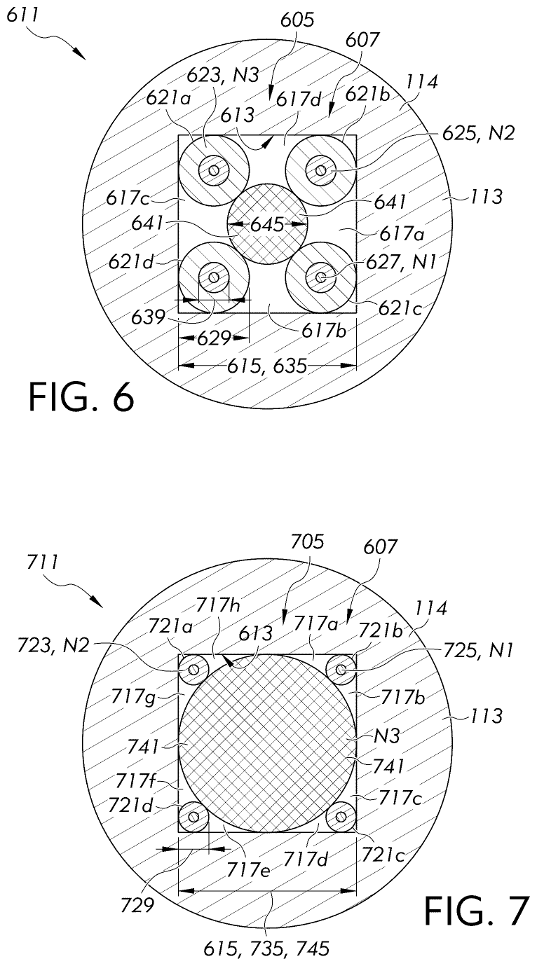

In aspects, as shown in FIGS. 4-5 and 8, a shape of the interior region 117 or 807 (e.g., the cross-section shown demarcated by inner surface 413 or 813 of the bulk 114) may have originally been and/or still comprise a substantially circular shape. In aspects, as shown in FIGS. 6-7 and 9, a shape of the interior region 607 (e.g., the cross-section shown demarcated by inner surface 413 of the bulk 114) may have originally been and/or still comprise a substantially quadrilateral shape (e.g., substantially square shape).

As shown in FIGS. 4-9, a plurality of optical fibers 405, 505, 605, 705, 805, and/or 905 are positioned within an interior region 117, 607, or 807 of the body 111, 511, 611, 711, 811, or 901 (e.g., that is collectively and circumferentially surrounded by the bulk 114). In aspects, as shown in FIGS. 4-5 and 8-9, adjacent edges of optical fibers in the plurality of optical fibers 405, 505, 805, and/or 905 can touch (e.g., without any material from the bulk 114 positioned therebetween). In aspects, as shown in FIGS. 4 and 6-7, material of the one or more spacers (e.g., single spacer 441, 641, and/or 741) can be positioned between the plurality of optical fibers 405, 605, and/or 705 (e.g., without any material from the bulk 114 positioned therebetween).

As used herein, refractive index is measured with a light beam having an optical wavelength of 1500 nanometers (nm) in accordance with the methods described following references that measure the deflection of the light beam: (1) Marcuse, “Refractive index determination by the focusing method,” Applied Optics, 1979(18): 9-13, and (2) Francois, et. al. “Practical three-dimensional profiling of optical fiber preforms,” IEEE J Quantum Electron, 1982 (18): 524-534. In aspects, a bulk refractive index nb or n4 of the bulk 114 can be about 1.435 or more, about 1.436 or more, about 1.437 or more, about 1.438 or more, about 1.439 or more, about 1.441 or less, about 1.440 or less, or about 1.439 or less, for example in a range from about 1.435 to about 1.441, from about 1.436 to about 1.440, from about 1.437 to about 1.440, from about 1.438 to about 1.439, or any range or subrange therebetween, although other values for the bulk refractive index nb or n4 can be provided in other aspects.

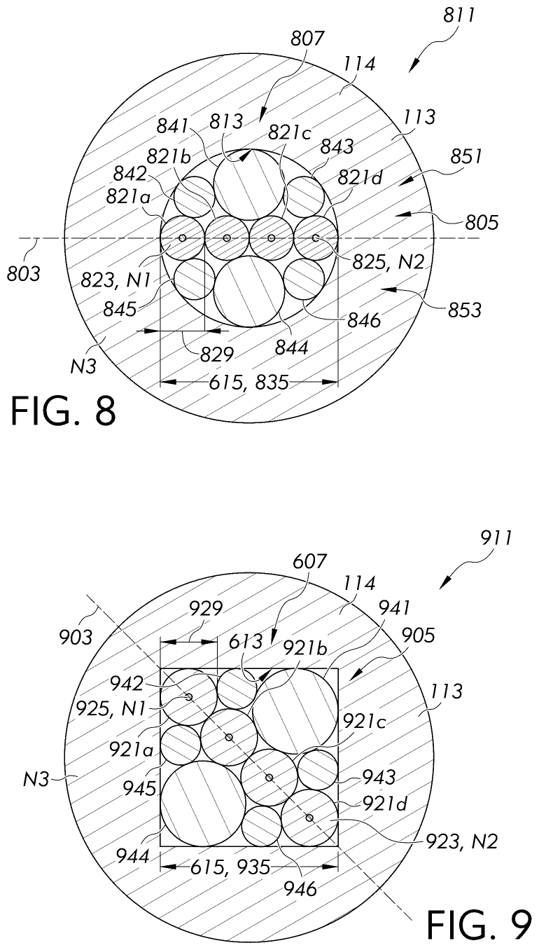

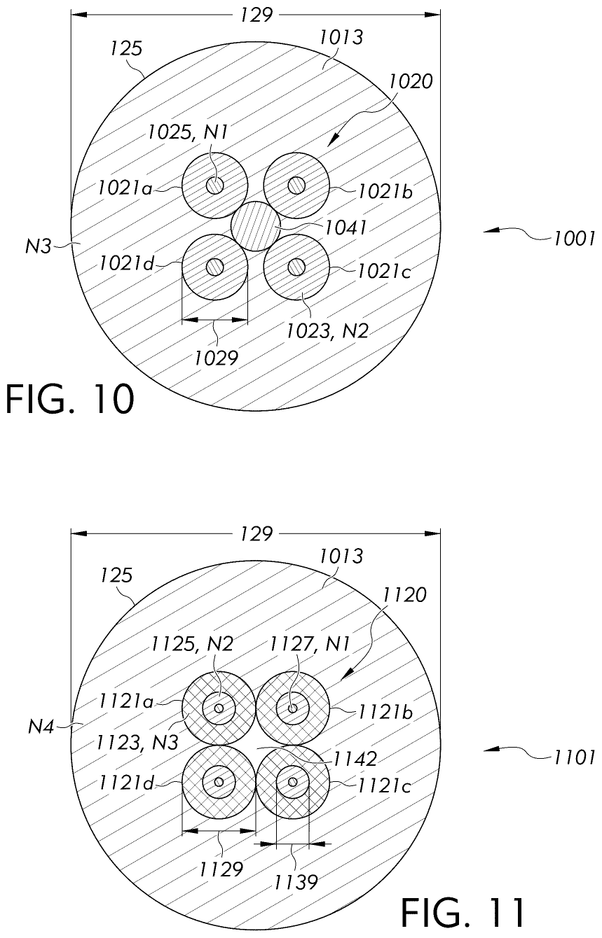

As shown by FIGS. 4-9 and 10-13 (e.g., compare FIG. 4 or 6 to FIG. 10, FIG. 5 to FIG. 11, FIG. 8 to FIG. 12, and/or FIG. 9 to FIG. 13), the plurality of optical fibers 405, 505, 605, 705, 805, and/or 905 (at the first end 123 and the corresponding optical fibers 1020, 1120, 1220, and/or 1320 at the second end 125) can extend from the first end 123 of the body 111, 511, 611, 711, 811, or 901 to the second end of the body 111, 511, 611, 711, 811, or 901, which enables the plurality of optical fibers to be optically coupled to a corresponding single-mode fiber 203a-203d of the plurality of single-mode fibers 103 at the first end 123 and optically coupled to a corresponding core 305a-305d of the multicore fiber 131 at the second end 125 to allow light and/or signals to propagate therethrough. With reference to FIGS. 5 and 11 (although generally applicable), a maximum dimension 429 of an optical fiber 421a of the plurality of optical fibers 505 at the first end 123 can be greater than a corresponding maximum dimension 1129 of a corresponding optical fiber 1121a of the plurality of optical fibers 1120 at the second end 125 (where the plurality of optical fibers 505 and 1120 would be the same for this particular combination). In aspects, a ratio of the maximum dimension of an optical fiber at the first end divided by to maximum dimension of the corresponding optical fiber at the second end can be within one or more of the corresponding ranges for the ratio of maximum dimensions for the body discussed above (e.g., from about 10 to about 100, from about 12 to about 16, or from about 14 to about 15).

In aspects, as shown in FIGS. 7-9, the plurality of optical fibers 705, 805, and/or 905 can comprise optical fibers 721a-721d with two distinct refractive index portions (e.g., core 725, 825, or 925 with a first refractive index n1 and cladding 723, 823, or 923 with a second refractive index n2). As shown, the cladding 723, 823, or 923 can circumferentially surround the core 725, 825, or 925. Although shown with the cladding having a uniform second refractive index n2, it is to be understood that the cladding can (in some aspects) comprise a gradient refractive index, but for simplicity, the greatest refractive index value of the gradient refractive index will be taken as the second refractive index. In further aspects, the second refractive index n2 can be less than the first refractive index n1. In further aspects, although not labeled, a maximum dimension of the core 725, 825, or 925 at the first end 123 can be within one or more of the ranges discussed above for the maximum dimension 219 of core 207a. In even further aspects, with reference to FIGS. 10 and 12-13 although not labeled, a maximum dimension of the core region 1025, 1225, or 1325 at the second end 125 can be about 1 μm or less (e.g., from about 0.1 μm to about 1.0 μm, from about 0.3 μm to about 0.95 μm, from about 0.5 μm to about 0.90 μm, from about 0.7 μm to about 0.85 μm, or any range or subrange therebetween). In such aspects, the core region 1025, 1225, or 1325 at the second end 125 can be too small to effectively confine light, where the light may be confined within the cladding 1023, 1223, or 1323 at the second end 125. For example, a maximum dimension 1029, 1229, or 1329 of the cladding 1023, 1223, or 1323 (corresponding to a maximum dimension of the optical fiber 1021a, 1221b, or 1321c) at the second end 125 can be about 8.98 μm or more, about 9.2 μm or more, about 9.5 μm or more, about 9.8 μm or more, about 9.9 μm or more, about 10.0 μm or more, about 12.22 μm or less, about 12.0 μm or less, about 11.5 um or less, about 11.0 μm or less, about 10.5 μm or less, about 10.2 μm or less, or about 10.1 μm or less. A maximum dimension 1029, 1229, or 1329 of the cladding 1023, 1223, or 1323 (corresponding to a maximum dimension of the optical fiber 1021a, 1221b, or 1321c) at the second end 125 can be in a range from about 8.98 μm to about 12.22 μm, from about 9.2 μm to about 12.0 μm, from about 9.2 μm to about 11.5 μm, from about 9.5 μm to about 11.0 μm, from about 9.8 μm to about 10.5 μm, from about 9.9 μm to about 10.2 μm, from about 10.0 μm to about 10.1 μm, or any range or subrange therebetween. In further aspects, confinement of light within the cladding 1023, 1223, or 1323 at the second end 125 can be facilitated by providing a third refractive index n3 (also nb or n4) of the bulk 1013 that is less than the second refractive index of the bulk. For example, a relationship between the second refractive index n2 of the cladding and the third refractive index n3 (also nb or n4) of the bulk Δn23=(n2²−n3²)/(n2²+n3²) that can be about 0.25 or more, about 0.28 or more, about 0.30 or more, about 0.32 or more, about 0.35 or more, about 0.38 or more, about 0.40 or more, about 0.53 or less, about 0.50 or less, about 0.48 or less, about 0.45 or less, about 0.42 or less, about 0.40 or less, or about 0.38 or less. The relationship Δn23 can be in a range from about 0.25 to about 0.53, from about 0.28 to about 0.50, from about 0.30 to about 0.48, from about 0.32 to about 0.45, from about 0.35 to about 0.42, from about 0.38 to about 0.40, or any range or subrange therebetween. Providing the maximum dimension of the cladding at the second end within one or more of the ranges mentioned above in this paragraph in combination with a value of Δn23 within one or more of the ranges mentioned above in this paragraph can facilitate low loss (e.g., 97.7% or more or 0.1 dB or less) optical coupling between the plurality of optical fibers and the multicore optical fiber. Returning to FIGS. 7-9, in aspects, a maximum dimension 729, 829, or 929 of the cladding 723, 823, or 923 (corresponding to a maximum dimension of the optical fiber 721a, 821a, or 921a) can be within one or more of the ranges discussed above with reference to the maximum dimension 209 of the single-mode fiber 203a or from about 60 μm to about 160 μm, from about 80 μm to about 150 μm, from about 100 um to about 140 μm, from about 110 μm to about 130 μm, or any range or subrange therebetween.

In aspects, as shown in FIGS. 4-6, the plurality of optical fibers 405, 505, and/or 605 can comprise optical fibers 421a-421d or 621a-621d with three distinct refractive index portion (e.g., core 427 or 627 with a first refractive index n1, a cladding 425 or 625 with a second refractive index n2, and an outer region 423 or 623 with a third refractive index n3). As shown, the three distinct regions with different refractive indices can be concentrically arranged with the outer region 423 or 623 surrounding (e.g., circumferentially surrounding) the cladding 425 or 625 that is, in turn, surrounding (e.g., circumferentially surrounding) the core 427 or 627. In further aspects, the second refractive index n2 can be less than the first refractive index n1, and/or the third refractive index n3 can be less than the second refractive index n2. In further aspects, although not labeled, a maximum dimension of the core 427 or 627 at the first end 123 can be within one or more of the ranges discussed above for the maximum dimension 219 of core 207a. In further aspects, as shown in FIG. 6, the cladding 627 can comprise a maximum dimension 639 at the first end 123 that can be within one or more of the ranges discussed above with reference to the maximum dimension 209 of the single-mode fiber 203a or from about 60 μm to about 160 μm, from about 80 μm to about 150 μm, from about 100 μm to about 140 μm, from about 110 μm to about 130 μm, or any range or subrange therebetween. In further aspects, as shown in FIGS. 4-6, the outer region 423 or 623 can comprise a maximum dimension 429 or 629 (corresponding to a maximum dimension of the optical fiber 421a or 621d can be about 200 μm or more, 210 μm or more, about 220 μm or more, about 230 μm or more, about 240 μm or more, about 250 μm or more, about 300 μm or more, about 500 μm or less, about 400 μm or less, about 350 μm or less, about 300 μm or less, about 280 μm or less, about 260 μm or less, about 250 μm or less, or about 240 μm or less. In further aspects, as shown in FIGS. 4-6, the outer region 423 or 623 can comprise a maximum dimension 429 or 629 (corresponding to a maximum dimension of the optical fiber 421a or 621d can be in a range from about 200 μm to about 500 μm, from about 210 μm to about 400 μm, from about 210 μm to about 350 μm, from about 220 μm to about 300 μm, from about 230 μm to about 280 μm, from about 240 μm to about 260 μm, from about 240 μm to about 250 μm, or any range or subrange therebetween.

Continuing the discussion of three-index fibers, in even further aspects, with reference to FIG. 11 although not labeled, a maximum dimension of the core region 1127 at the second end 125 can be about 1 μm or less (e.g., from about 0.1 μm to about 1.0 μm, from about 0.3 μm to about 0.95 μm, from about 0.5 μm to about 0.90 μm, from about 0.7 μm to about 0.85 μm, or any range or subrange therebetween). In such aspects, the core region 1127 at the second end 125 can be too small to effectively confine light, where the light may be confined within the cladding 1125 at the second end 125. For example, a maximum dimension 1139 of the cladding 1125 at the second end 125 can be about 8.98 μm or more, about 9.2 μm or more, about 9.5 μm or more, about 9.8 μm or more, about 9.9 μm or more, about 10.0 μm or more, about 12.22 μm or less, about 12.0 μm or less, about 11.5 μm or less, about 11.0 μm or less, about 10.5 μm or less, about 10.2 μm or less, or about 10.1 μm or less. A maximum dimension 1139 of the cladding 1125 at the second end 125 can be in a range from about 8.98 μm to about 12.22 μm, from about 9.2 μm to about 12.0 μm, from about 9.2 μm to about 11.5 μm, from about 9.5 μm to about 11.0 μm, from about 9.8 μm to about 10.5 μm, from about 9.9 μm to about 10.2 μm, from about 10.0 μm to about 10.1 μm, or any range or subrange therebetween. In further aspects, confinement of light within the cladding 1125 at the second end 125 can be facilitated by providing the barrier region 1123 with the third refractive index n3 that is less than the second refractive index of the cladding 1125. For example, the third refractive index n3 of the barrier region 1123 can be within one or more of the ranges discussed above for the bulk refractive index nb or n4. A relationship between the second refractive index n2 of the cladding and the third refractive index n3 of the barrier region Δn23=(n2²⁻n3²)/(n2²⁺n3²) can be about 0.25 or more, about 0.28 or more, about 0.30 or more, about 0.32 or more, about 0.35 or more, about 0.38 or more, about 0.40 or more, about 0.53 or less, about 0.50 or less, about 0.48 or less, about 0.45 or less, about 0.42 or less, about 0.40 or less, or about 0.38 or less. The relationship Δn23 can be in a range from about 0.25 to about 0.53, from about 0.28 to about 0.50, from about 0.30 to about 0.48, from about 0.32 to about 0.45, from about 0.35 to about 0.42, from about 0.38 to about 0.40, or any range or subrange therebetween. Providing the maximum dimension of the cladding at the second end within one or more of the ranges mentioned above in this paragraph in combination with a value of Δn23 within one or more of the ranges mentioned above in this paragraph can facilitate low loss (e.g., 97.7% or more or 0.1 dB or less) optical coupling between the plurality of optical fibers and the multicore optical fiber.

In aspects, as shown in FIGS. 4-7 (and 10-11), the plurality of optical fibers 405, 505, 605, and 705 (and 1020 and 1120) are arranged in a two-dimensional array with at least two optical fibers arranged in each direction (e.g., dimension) of the two-dimensional array. For example, with reference to FIG. 4, the plurality of optical fibers 405 comprise a two-dimensional array with two rows and two columns with two optical fibers in a row (e.g., optical fibers 421a and 421b) and two optical fibers in a column (e.g., optical fibers 421a and 421c. In further aspects, as shown in FIGS. 4-7 (and 10-11), the plurality of optical fibers 405, 505, 605, and 705 (and 1020 and 1120) can comprise and/or consist of 4 optical fibers arranged in a 2 by 2 arrangement. In other aspects, although not shown, six optical fibers can be arranged in a 2 by 3 arrangement, or eight optical fibers can be arranged in a 2 by 4 arrangement in other aspects.

In aspects, as shown in FIGS. 4 and 6-9, one or more spacers 441, 641, 741, 841-846, and/or 941-946 can also be positioned in the interior region 117, 607, or 807 along with the plurality of optical fibers 405, 605, 705, 805, and/or 905. In aspects, as shown in FIG. 5, a spacer may not be present in the interior region 117 (e.g., no spacer between the plurality of optical fibers 505 and/or otherwise located in the interior region 117).

FIGS. 4-5 show a plurality of optical fibers 405 or 505 comprising four optical fibers 421a-421d in a 2 by 2 arrangement positioned in an interior region 117 (e.g., circular interior region) of the body 111 and 511. In aspects, as shown, the plurality of optical fibers 405 can be three-index optical fibers, although two-index fibers (e.g., see FIG. 7) can be provided in other aspects. In aspects, as shown in FIG. 4, one or more spacers (e.g., a single spacer 441) can be positioned between the plurality of optical fibers 405, which can serve to stabilize an arrangement of the plurality of optical fibers during manufacturing that can be desirable for easy alignment of the with the plurality of single-mode fibers and/or multimode fiber at the ends. Although not shown, it is to be understood that two-index fibers can be positioned in a circular interior region in a 2 by 2 arrangement. Alternatively, in aspects, as shown in FIG. 5, the interior region 117 can consist of the plurality of optical fibers 505 (without any spacers). The three-index optical fibers shown can be large enough to be locked into a relative arrangement without spacers. In further aspects, omitting a spacer can facilitate the optical fibers maintaining a substantially circular shape. Also, as shown in FIGS. 4-5, a dimension 415 (e.g., maximum dimension) of the single hole corresponding to the interior region 117 can be substantially equal to a corresponding combined dimension 435 or 535 (e.g., maximum combined dimension) of the plurality of optical fibers 405 or 505 and any spacers (e.g., single spacer 441), which can enable a relative arrangement of the plurality of optical fibers to be maintained. As shown in FIGS. 4-5, there are initial air gaps 417a-417d positioned between the plurality of optical fibers 405 or 505 and the inner surface 413 of the bulk 114.

FIGS. 6-7 show a plurality of optical fibers 605 or 705 comprising four optical fibers 621a-621d or 721a-721d in a 2 by 2 arrangement positioned in a quadrilateral (e.g., substantially square) interior region 607 of the body 611 or 711. As shown, one or more spacers (e.g., a single spacer 641 or 741) can be positioned in the interior region 607, for example, to enable a relative arrangement of the plurality of optical fibers to be maintained. For example, FIGS. 6-7 show a single spacer 641 or 741 can be centered in the interior region 607 with the plurality of optical fibers 605 or 705 positioned in the corners of the quadrilateral (e.g., substantially square) interior region 607. In aspects, as shown in FIG. 6, a maximum dimension 645 of the single spacer 641 can be less than a dimension 615 of the interior region 607, for example, the maximum dimension 645 can be within one or more of the ranges discussed above for the maximum dimension 629 of an optical fiber 621d (three-index optical fiber). Alternatively, in aspects, as shown in FIG. 7, a maximum dimension 745 of the single spacer 741 can be substantially equal to a corresponding dimension 615 of the interior region 607. In aspects, as shown in FIG. 6, the plurality of optical fibers 605 comprise three-index optical fibers. Alternatively, in aspects, as shown in FIG. 7, the plurality of optical fibers 705 comprise two-index optical fibers. Also, as shown in FIGS. 6-7, a dimension 615 of the single hole corresponding to the interior region 607 can be substantially equal to a corresponding combined dimension 635 or 735 (e.g., maximum combined dimension) of the plurality of optical fibers 605 or 705 and any spacers (e.g., single spacer 641 or 741), which can enable a relative arrangement of the plurality of optical fibers to be maintained. As shown in FIGS. 6-7, there are initial air gaps 617a-617d or 717a-717h positioned between the plurality of optical fibers 605 or 705 and the inner surface 613 of the bulk 114.

FIGS. 10-11 schematically show coalesced cross-sections 1001 and 1101 corresponding to the second end 125 of the body. As shown, the bulk 1013 is closer (or in contact) with the plurality of optical fibers 1020 or 1120; however, there still exists a continuous interior region defined by the boundaries of the plurality of optical fibers 1020 or 1120 and includes the space therein (including spacer 1040 and/or a central air gap 1142). The arrangement shown in FIG. 10 can correspond to the body 711 shown in FIG. 7. Also, the arrangement shown in FIG. 10 could correspond to the body 111 or 611 shown in FIG. 4 or 6 (if the plurality of optical fibers in FIG. 10 were three-index fibers or if the plurality of optical fibers in FIG. 4 or 6 were two-index fibers). The arrangement shown in FIG. 11 can correspond to the body 511 shown in FIG. 5.

In aspects, as shown in FIGS. 8-9 (and 12-13), the plurality of optical fibers 805, and 905 (and 1220 and 1320) are arranged in a single line. For example, with reference to FIGS. 8-9, the plurality of optical fibers 805 or 905 comprise 4 optical fibers arranged in a single line 803 or 903. In other aspects, although not shown, the plurality of optical fibers arranged in a single line can comprise 5 optical fibers, 6 optical fibers, or 8 optical fibers in other aspects. In aspects, as shown in FIGS. 8-9, one or more spacers 841-846, and/or 941-946 can also be positioned in the interior region 607 or 807 along with the plurality of optical fibers 805 or 905. In aspects, as shown in FIGS. 8, the one or more spacers can comprise a plurality of spacers with a first set of spacers 851 on one side of the single line 803 and a second set of spacers 853 on the other side of the single line 803 (i.e., spacers positioned on either side of the single line). For example, as shown in FIG. 8, the one or more spacers can comprise six spacers 841-846 positioned on either side of the single line 803 (e.g., plurality of optical fibers 805 arranged in a single line 803) with a first set of spacers 851 comprising spacers 841-843 on one side of the single line 803 and a second set of spacers 853 comprising spacers 844-846 on the other side of the single line 803.

FIGS. 8-9 show a plurality of optical fibers 805 or 905 comprising four optical fibers 821a-821d or 921a-921d arranged in a single line 803 or 903 positioned in an interior region 807 or 607 of the body 811 or 911. In aspects, as shown, the plurality of optical fibers 805 or 905 can be two-index optical fibers, although three-index fibers can be provided in other aspects. In aspects, as shown in FIG. 8, the plurality of optical fibers 805 comprise four optical fibers 821a-821d arranged in a single line 803 positioned in an interior region 807 comprising a circular shape. Alternatively, as shown in FIG. 9, the plurality of optical fibers 905 comprises four optical fibers 921a-921d arranged in a single line 903 positioned in an interior region 607 comprising a quadrilateral (e.g., substantially square) shape, for example, with the single line 903 extending along a diagonal of the quadrilateral (e.g., substantially square shape). In aspects, as shown in FIGS. 8-9, a plurality of spacers 841-846 or 941-946 can be positioned on either side of the plurality of optical fibers 805 or 905 arranged in a single line 803 or 903 Also, as shown in FIGS. 8-9, a dimension 415 or 615 of the single hole corresponding to the interior region 607 or 807 can be substantially equal to a corresponding combined dimension 835 or 935 of the plurality of optical fibers 805 or 905 and the plurality of spacers 841-846 or 941-946, which can enable a relative arrangement of the plurality of optical fibers to be maintained.

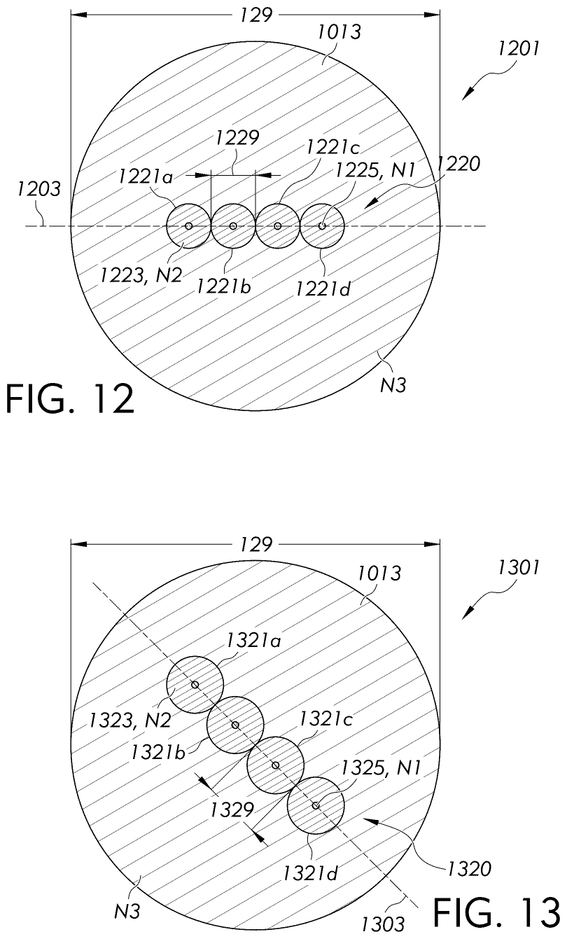

FIGS. 12-13 schematically show coalesced cross-sections 1201 and 1301 corresponding to the second end 125 of the body. As shown, the bulk 1013 is closer (or in contact) with the plurality of optical fibers 1220 or 1320; however, there still exists a continuous interior region defined by the boundaries of the plurality of optical fibers 1020 or 1120. The plurality of optical fibers 1220 or 1320 (e.g., optical fibers 1221a-1221d or 1321a-1321d) arranged in a single line 1203 or 1303.

In aspects, an optical fiber of the optical fiber fanout 101 can be configured to transmit about 97.7% or more of light from a single-mode fiber of the plurality of single-mode fibers 103 through the optical fiber running through the body 111, 511, 611, 711, 811, or 911 from the first end 123 to the second end 125 and to the multicore fiber 131 for at least one optical wavelength in a range from 1200 nm to 1650 nm. In further aspects, the 97.7% or more transmission can be achieved for an optical wavelength of 1500 nm and/or 1550 nm. In further aspects, the 97.7% or more transmission can be achieved for an entire 100 nm continuous sub-range of optical wavelengths in the range from 1200 nm to 1650 nm (e.g., from 1450 nm to 1550 nm, from 1500 nm to 1600 nm). In further aspects, the 97.7% or more transmission can be achieved over the entire range of optical wavelengths from 1200 nm to 1650 nm.

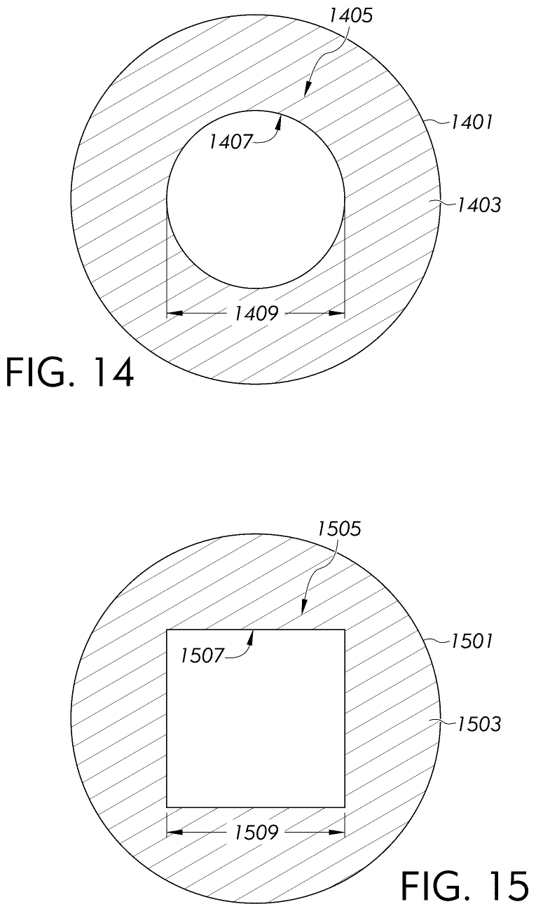

Aspects of methods of making an optical fiber fanout in accordance with the aspects of the present disclosure will now be discussed with reference to FIGS. 14-20 and the cross-sectional views shown in FIGS. 4-12. As shown in FIGS. 14-15, methods can start with providing a glass cane 1401 or 1501 comprising a single hole 1405 or 1505 therein (e.g., running in a direction of the length of the glass cane corresponding to a direction into the page of FIGS. 14-15). Glass cane can be provided through a number of methods, for example, by purchase or by forming a (hollow) fiber preform (e.g., through extrusion, slot die, or similar methods). As shown, the glass cane 1401 or 1501 can comprise a bulk 1403 surrounding the single hole 1405 or 1505 (e.g., with an inner surface 1407 or 1507 of the bulk 1403 indicating the boundary of the single hole 1405 or 1505). In aspects, the bulk 1403 can comprise a refractive index within one or more of the ranges discussed above for the bulk refractive index nb or n4. In aspects, as shown in FIG. 14, the single hole 1405 (and/or the inner surface 1407) can comprise a substantially circular cross-sectional shape, for example, to produce the cross-section shown in any of FIGS. 4-5 and 8 (and/or 10-13). In further aspects, a dimension 1409 of the single hole 1405 corresponds to the maximum dimension (e.g., diameter) of the single hole 1405 with the circular cross-section, and the dimension 1409 can be substantially equal to the dimension 415 shown in FIGS. 4-5 and 8. Alternatively, in aspects, as shown in FIG. 15, the single hole 1505 (and/or the inner surface 1507) can comprise a quadrilateral (e.g., substantially square) cross-sectional shape, for example, to produce the cross-section shown in any of FIGS. 6-7 and 9 (and/or 10-13). In further aspects, a dimension 1509 of the single hole 1505 can correspond to a length of a side of the quadrilateral shape and can be substantially equal to the dimension 615 shown in FIGS. 6-7 and 9.

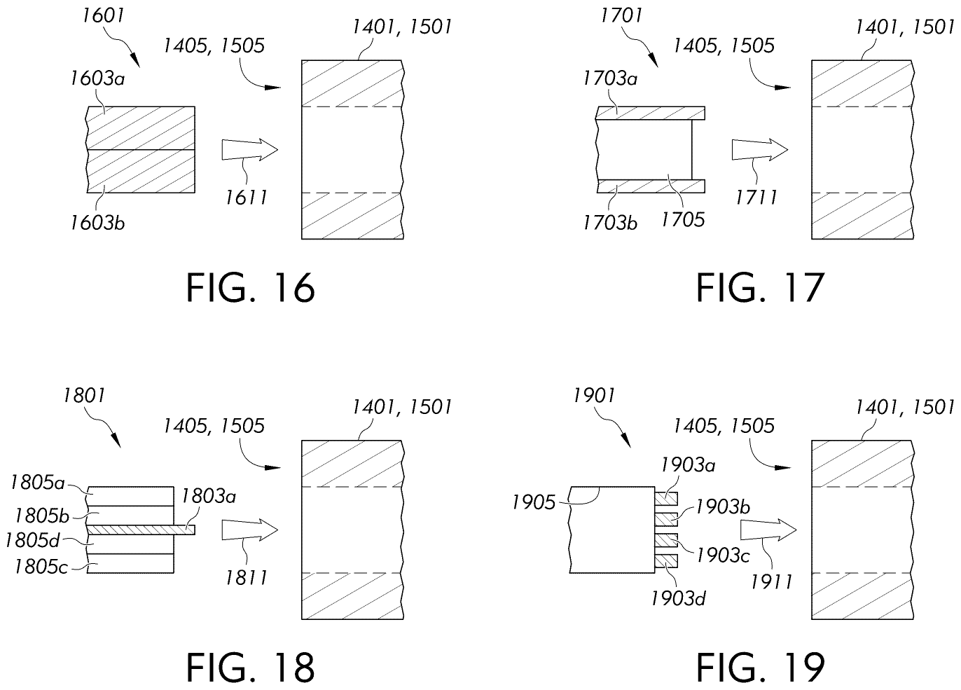

As shown in FIGS. 16-19, methods can proceed to inserting (as indicated by arrows 1611, 1711, 1811, and 1911) a bundle of a plurality of optical fibers 1601, 1701, 1801, or 1901 and optionally one or more spacers 1705, 1805a-c, or 1905 in the single hole 1405 or 1505 of the glass cane 1401 or 1501. In aspects, a cross-sectional dimension (e.g., combined dimension 435, 535, 635, 735, 835, or 935) of the bundle of the plurality of optical fibers and optionally one or more spacers can be substantially equal to a corresponding dimension (e.g., dimension 1409 or 1509) of the single hole 1405 or 1505, which can facilitate a relative arrangement of the plurality of optical fibers being maintained throughout the method of making the optical fiber fanout. In aspects, as shown in FIG. 16, the bundle of the plurality of optical fibers 1601 (with optical fibers 1603a and 1603b shown) can be arranged in a two-dimensional array (e.g., in a 2 by 2 arrangement) without any visible spacers (in the side view shown in FIG. 16) that can correspond to the cross-sectional view shown in any of FIGS. 4-5. For example, no spacers may be inserted in the single hole 1405 or 1505 in some aspects (e.g., see FIGS. 5 and 16). In aspects, as shown in FIG. 17, the bundle of the plurality of optical fibers 1701 (with optical fibers 1703a and 1703b shown) can be arranged in a two-dimensional array (e.g., in a 2 by 2 arrangement) with a single spacer 1705 visible (in the side view shown in FIG. 17) that can correspond to the cross-sectional view shown in any of FIGS. 6-7. In aspects, as shown in FIG. 18, the bundle of the plurality of optical fibers 1801 with a single optical fiber 1803a visible can be arranged in a single line that is surrounded by a plurality of spacers 1805a-1805d visible (in the side view shown in FIG. 18) and that can correspond to the cross-sectional view shown in FIG. 8. In aspects, as shown in FIG. 19, the bundle of the plurality of optical fibers 1901 with multiple optical fibers 1903a-d visible can be arranged in a single line (e.g., diagonally) with a single spacer 1905 visible (in the side view shown in FIG. 19) and that can correspond to the cross-sectional view shown in FIG. 9. In aspects, as discussed above in this paragraph (e.g., with reference to FIGS. 4 and 16), the bundle can consist of the plurality of optical fibers without any spacers being inserted into the single hole, for example, when a cross-sectional shape of the single hole is quadrilateral (e.g., substantially square), the plurality of optical fibers are three-index optical fibers, and/or the plurality of optical fibers are arranged in a two-dimensional matrix with at least two optical fibers in each dimension (e.g., direction) (e.g., a 2 by 2 arrangement). Alternatively, in aspects, as discussed above in this paragraph (e.g., with reference to FIGS. 4, 6-9, and 16-19, the bundle can comprise one or more spacers in addition to the plurality of optical fibers inserted into the single hole. In further aspects, as discussed with reference to FIGS. 4, 6-7, and 16-17, the bundle can comprise a single spacer in addition to the plurality of optical fibers inserted into the single hole, for example when the plurality of optical fibers are arranged in a two-dimensional matrix with at least two optical fibers in each dimension (e.g., direction) (e.g., a 2 by 2 arrangement). In further aspects, as discussed with reference to FIGS. 8-9 and 18-19, the bundle can comprise a plurality of spacers in addition to the plurality of optical fibers inserted into the single hole, for example when the plurality of optical fibers are arranged in a single line (e.g., arranged in a single line of 4 optical fibers) with the plurality of spacers positioned around (e.g., on either side) of the single line.

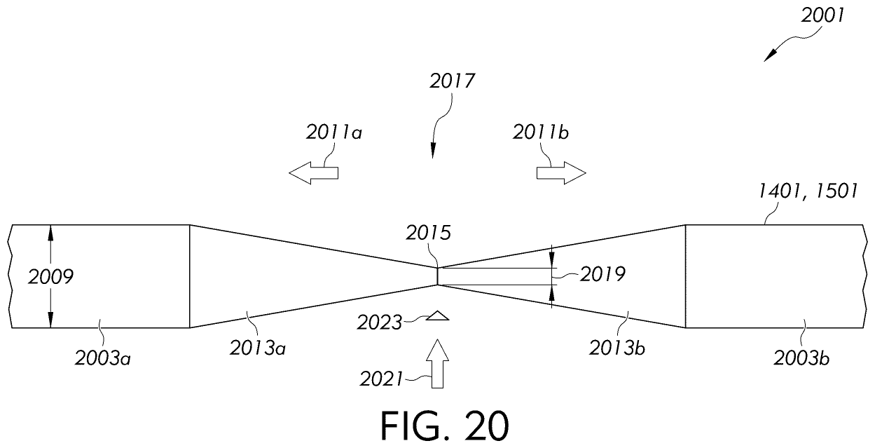

After inserting the bundle of the plurality of optical fibers and optionally one or more spacers in the single hole of the glass case, as shown in FIG. 20, methods can proceed to drawing (as indicated by arrow 2011a and 2011b) a central portion 2017 of the glass cane 1401 or 1501 (with the bundle positioned in the single hole) to form a necked cane 2001. In aspects, as shown, the necked cane can be symmetric about a midpoint 2015 of the central portion 2017. In aspects, end portions 2003a and 2003b of the glass cane 1401 or 1501 can comprise a substantially constant cross-sectional dimension 2009 that can be substantially equal to the maximum dimension 119 at the first end 123 of the resulting optical fiber fanout 101 (see FIG. 1). In aspects, drawing can comprise heating at least a portion of the glass cane (e.g., central portion) and/or applying a force (e.g., gravity or pulling the end portions apart). In aspects, the drawing (arrows 2011a and 2011b) can form tapered portions 2013a and 2013b where a cross-sectional dimension decreases from the substantially constant cross-sectional dimension 2009 of the end portions 2003a and 2003b to a second cross-sectional dimension 2019 at the midpoint 2015 of the central portion 2017. As shown, the substantially constant cross-sectional dimension 2009 of the end portions 2003a and 2003b is greater than the second cross-sectional dimension 2019 at the midpoint 2015 of the central portion 2017. In further aspects, a ratio of the (first) substantially constant cross-sectional dimension 2009 of the end portions 2003a and 2003b divided by the second cross-sectional dimension 2019 at the midpoint 2015 of the central portion 2017 can be within one or more of the ranges discussed above for the ratio the first dimension (e.g., maximum dimension 119) of the body 111, 511, 611, 711, 811, or 901 to the second dimension (e.g., maximum dimension 129) at the second end 125 of the body 111, 511, 611, 711, 811, or 901 and/or the ratio can be substantially equal to the corresponding ratio of the resulting optical fiber fanout 101.

Then, as further shown in FIG. 20, methods can proceed to dividing the necked cane 2001 at a middle (e.g., midpoint 2015 of the central portion 2017) between the tapered portions 2013a and 2013b to form two divided tapered canes. For example, a sharp tool 2023 can impinge the midpoint 2015 (as indicated by arrow 2021), although any method of separating glass cane and/or optical fiber can be used in other aspects. Each divided tapered cane has a first end 123 (see FIG. 1) corresponding to the end portion 2003a or 2003b opposite a second end 125 corresponding to the midpoint 2015 where the necked cane 2001 was divided. Consequently, the divided tapered cane can resemble the optical fiber fanout without the plurality of single-mode fibers optically coupled at the first end and the multicore fiber coupled at the first end. In aspects, methods can be complete at this stage with the optical fiber fanout being implemented in an optical fiber system by splicing (e.g., fusion splicing) the plurality of single-mode fibers and the multicore fiber to respective ends of the divided tapered cane. Alternatively, in aspects, methods can further proceed to splicing (e.g., fusion splicing) the plurality of single-mode fibers and the multicore fiber to respective ends of the divided tapered cane to form the optical fiber fanout 101 shown in FIG. 1. For example, the plurality of single-mode fibers 103 can be aligned with a corresponding plurality of optical fibers in the divided tapered cane (at the first end) and fusion spliced so that plurality of single-mode fibers are optically coupled to the corresponding plurality of optical fibers. Similarly, the plurality of cores of the multicore fiber can be aligned with a corresponding plurality of optical fibers (at the second end) and fusion spliced so that the plurality of cores of the multicore fiber are optically coupled to the corresponding plurality of optical fibers. In aspects, methods of making the optical fiber fanout can now be complete. The dimensions and/or properties of the optical fiber fanout or components thereof can satisfy one or more of the corresponding aspects discussed above. For example, an optical fiber of the optical fiber fanout 101 can be configured to transmit about 97.7% or more of light from a single-mode fiber of the plurality of single-mode fibers 103 through the optical fiber running through the body 111, 511, 611, 711, 811, or 911 from the first end 123 to the second end 125 and to the multicore fiber 131 for at least one optical wavelength in a range from 1200 nm to 1650 nm, at 1500 nm and/or 1550 nm, an entire 100 nm continuous sub-range therein, and/or the entire range from 1200 nm to 1650 nm.

### EXAMPLES

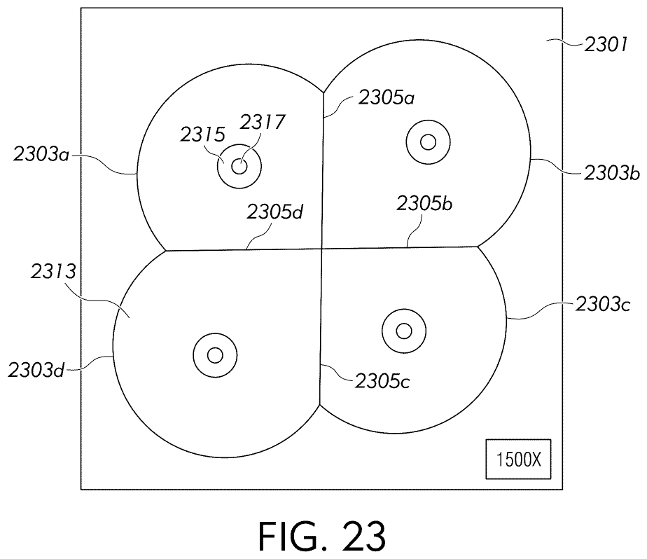

Various aspects will be further clarified by the following working embodiment in accordance with aspects of the present disclosure. An optical fiber fanout was constructed by inserting a plurality of optical fibers (i.e., 4 three-index optical fibers) in a single hole (i.e., circular single hole) of a glass cane (see schematic cross-section in FIG. 5) with a dimension of the plurality of optical fibers (i.e., twice the diameter of the three-index fibers) substantially equal to a corresponding dimension of the circular single hole. The glass cane with the plurality of optical fibers positioned therein was drawn to form a necked cane with a ratio of the initial dimension (at the end portions) to a dimension at the midpoint of the central portion (having the smallest cross- sectional dimension) of 14.5. FIGS. 21-23 schematically show cross-sectional views of the resulting optical fiber fanout taken with an optical microscope using objectives with 250×, 500×, and 1250× magnification, respectively. The cross-sectional view schematically shown FIG. 21 corresponds to the first end 123 of the optical fiber fanout, the cross-sectional view schematically shown FIG. 23 corresponds to the second end 125 of the optical fiber fanout, and the cross-sectional view schematically shown FIG. 22 corresponds to a midpoint between the first end 123 and the second end 125.

FIG. 21 shows the 4 optical fibers 2103a-2103d in a 2 by 2 arrangement with the three-index optical fibers having a core 2117 surrounded by cladding 2115 that is, in turn, surrounded by the barrier region 2113. Although not labeled, the optical fibers 2103a-2103d in FIG. 21 comprised a cross-sectional dimension of about 250 μm. As shown, adjacent pairs of optical fibers contact one another at interfaces 2105a-2105d. Also, as shown, there are a plurality of air gaps 2123a-2123d on the periphery of interfaces 2105a-2105d and a central air gap 2121 in the middle of plurality of optical fibers. Consequently, an interior region defined by the plurality of optical fibers 2103a-2103d and air gaps 2121 and 2123a-2123d that is surrounded by the bulk 2101 of the glass cane. The bulk 2101 does not extend in this interior region. From this cross-sectional view, the interfaces 2105a-2105d between adjacent pairs of optical fibers (without bulk positioned therebetween) and the presence of the air gaps 2121 and 2123a-2123d are telltale signs of methods in accordance with the present disclosure.

FIG. 22 also shows the 4 optical fibers 2203a-2203d (corresponding to optical fibers 2103a-2103d in FIG. 21) in a 2 by 2 arrangement with the three-index optical fibers having a core 2217 surrounded by cladding 2215 that is, in turn, surrounded by the barrier region 2213. Although not labeled, the optical fibers 2203a-2203d in FIG. 22 comprised a cross-sectional dimension of about 210 μm. As shown, adjacent pairs of optical fibers contact one another at interfaces 2205a-2205d. Unlike FIG. 21, FIG. 22 does not show any air gaps, indicating that the drawing process has caused the plurality of optical fibers and bulk to coalesce as the cross-sectional dimension decreases. Consequently, an interior region defined by the plurality of optical fibers 2203a-2203d. The bulk 2201 does not extend in this interior region. From this cross-sectional view, the interfaces 2205a-2205d between adjacent pairs of optical fibers (without bulk positioned therebetween) is still a telltale sign of methods in accordance with the present disclosure.

FIG. 23 also shows the 4 optical fibers 2303a-2303d (corresponding to optical fibers 2103a-2103d in FIGS. 21 and 2203a-2203d in FIG. 22) in a 2 by 2 arrangement with the three-index optical fibers having a core 2317 surrounded by cladding 2315 that is, in turn, surrounded by the barrier region 2313. Specifically, the relative arrangement of the plurality of optical fibers is maintained between FIGS. 21-23. Although not labeled, the optical fibers 2103a-2103d in FIG. 23 comprised a cross-sectional dimension of about 110 μm with a cross-sectional dimension of the cladding 2315 of about 10 μm. As shown, adjacent pairs of optical fibers contact one another at interfaces 2305a-2305d. Consequently, an interior region is defined by the plurality of optical fibers 2303a-2303d. The bulk 2301 does not extend in this interior region. From this cross-sectional view, the interfaces 2305a-2305d between adjacent pairs of optical fibers (without bulk positioned therebetween) is still a telltale sign of methods of the present disclosure.

The above observations can be combined to provide optical fiber fanouts and method of making the same. The optical fiber fanout can optically couple a plurality of single-mode fibers at one end to a multicore fiber at the other end through a plurality of optical fibers in the optical fiber fanout running therebetween. The plurality of optical fibers are positioned in an interior region of the optical fiber fanout that is collectively surrounded by a bulk of a body of the optical fiber fanout without any of the bulk positioned in the interior region. A variety of arrangements of the optical fiber fanouts can be formed using the plurality of optical fibers and optionally one or more spacers in the interior region. For example, the plurality of optical fibers can be arranged in a two-dimensional array with at least two optical fibers arranged in each dimension (e.g., a 2 by 2 arrangement) with a spacer (e.g., single spacer) optionally positioned therebetween. Also, in aspects, the plurality of optical fibers can be arranged in a single line (e.g., 4 optical fibers arranged in a single line) with a plurality of optical fibers positioned around (e.g., on each side) of the single line. The dimensions and/or refractive index of the plurality of optical fibers at each end of the optical fiber fanout can enable 97.7% or more (e.g., 0.1 dB or less loss) for light transmitted therethrough from the plurality of single-mode fibers to the multicore fiber.

Methods of the present disclosure comprise inserting a bundle comprising a plurality of optical fibers and optionally one or more spacers in a single hole in a glass cane. Inserting the plurality of optical fibers in a single hole can enable a relatively simple assembly of the optical fiber fanout. For example, a relatively large single hole can facilitate registration (e.g., alignment) of the bundle with the hole and/or the inserting can be performed in a single step, which can reduce the time and/or effort associated with making an optical fiber fanout. In aspects, a maximum dimension the bundle (e.g., collective dimension) can be substantially equal to a corresponding dimension of the single hole, which can enable a relative arrangement of the plurality of optical fibers to be maintained (e.g., locked in) throughout processing. In aspects, a cross-sectional shape of the single hole can be substantially circular or quadrilateral (e.g., substantially square), which in combination with the arrangement of the plurality of optical fibers and optionally one or more spacers in the bundle can enable a relative arrangement of the plurality of optical fibers to be maintained (e.g., locked in) throughout processing. Methods can further comprise drawing a center of the glass cane (with the bundle positioned therein), dividing the cane, and/or fusion splicing a plurality of single-mode fibers and a multicore fiber to corresponding ends of the resulting product to form the optical fiber fanout.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations. It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.” Directional terms as used herein—for example, up, down, right, left, front, back, top, bottom-are made only with reference to the figures as drawn and are not intended to imply absolute orientation.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including,” and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed is:

1. An optical fiber fanout comprising:
a body comprising a first end and a second end opposite the first end, the body tapers from a first dimension at the first end to a second dimension at the second end, the first dimension greater than the second dimension, the body further comprising:
a plurality of optical fibers within an interior region of the body that is collectively surrounded by a bulk of the body, the plurality of optical fibers extending from the first end to the second end, and a maximum dimension of an optical fiber of the plurality of optical fibers tapers from the first end to the second end with the maximum dimension at the first end greater than the maximum dimension at the second end; and
the bulk of the body that does not extending to the interior region;
a plurality of single-mode fibers optically coupled to the corresponding plurality of optical fibers at the first end; and
a multicore fiber optically coupled to the plurality of optical fibers at the second end.

2. The optical fiber fanout of claim 1, wherein a ratio of the first dimension to the second dimension is in a range from 10 to 100.

3. The optical fiber fanout of claim 2, wherein the optical fiber of the plurality of optical fibers is configured to transmit about 97.7% or more of light from a single-mode fiber of the plurality of single-mode fibers, through the optical fiber from the first end to the second end, and to the multicore fiber for at least one optical wavelength in a range from 1200 nanometers to 1650 nanometers.

4. The optical fiber fanout of claim 1, wherein each optical fiber of the plurality of optical fibers comprises three distinct refractive index portions concentrically arranged in the following sequence from an inside going outwards: a first region, a second region, and a third region.

5. The optical fiber fanout of claim 4, wherein the maximum dimension of the optical fiber of the plurality of optical fibers at the first end of the body is from about 200 micrometers to about 500 micrometers.

6. The optical fiber fanout of claim 1, wherein each optical fiber of the plurality of optical fibers consists of two distinct refractive index portions concentrically arranged with a first region surrounded by a second region.

7. The optical fiber fanout of claim 6, wherein the maximum dimension of the optical fiber of the plurality of optical fibers is from about 60 micrometers to about 160 micrometers.

8. The optical fiber fanout of claim 1, wherein the maximum dimension of the optical fiber at the second end of the body is from 8.98 micrometers to 12.22 micrometers.

9. The optical fiber fanout of claim 1, wherein the plurality of optical fibers are arranged in a two-dimensional array with at least two optical fibers of the plurality of optical fibers in each dimension of the two-dimensional array.

10. The optical fiber fanout of claim 9, wherein the interior consists of the plurality of optical fibers.

11. The optical fiber fanout of claim 9, wherein the interior consists of the plurality of optical fibers and one or more spacers positioned therebetween.

12. The optical fiber fanout of claim 1, wherein the plurality of optical fibers are arranged in a single line.

13. The optical fiber fanout of claim 12, wherein the interior consists of the plurality of optical fibers and a plurality of spacers positioned on either side of the plurality of optical fibers around the single line.

14. A method of forming an optical fiber fanout comprising:
inserting a plurality of optical fibers and optionally one or more spacers in a single hole in a glass cane; then
drawing a center of the glass cane to form a taper in a central portion of the glass cane to form a necked cane with the plurality of optical fibers positioned therein;
dividing the necked cane at a middle of the taper to form a body with a first end corresponding to an untapered end of the body and a second end opposite the first end at a tapered end of the body;
fusion splicing a multicore fiber at the second end of the body positioned to be optically coupled to the plurality of optical fibers; and
fusion splicing a plurality of single-mode fibers at the first end of the body positioned to be optically coupled to a corresponding optical fiber of the plurality of optical fibers.

15. The method of claim 14, wherein the plurality of optical fibers and optionally one or more spacers are arranged to have a first maximum cross-sectional dimension, and the first maximum cross-sectional dimension is substantially equal to a corresponding cross-sectional dimension of the single hole in the glass cane.

16. The method of claim 14, wherein a cross-sectional shape of the single hole is quadrilateral.

17. The method of claim 16, wherein the plurality of optical fibers are arranged in a two-dimensional array with at least two optical fibers of the plurality of optical fibers in each dimension of the two-dimensional array.

18. The method of claim 14, wherein a cross-sectional shape of the single hole is substantially circular, and the plurality of optical fibers are arranged in a single line.

19. The method of claim 14, wherein the optical fiber of the plurality of optical fibers is configured to transmit about 97.7% or more of light from a single-mode fiber of the plurality of single-mode fibers, through the optical fiber from the first end to the second end, and to the multicore fiber for at least one optical wavelength in a range from 1200 nanometers to 1650 nanometers.

20. The method of claim 14, wherein a maximum dimension of the optical fiber at the second end of the body is from 8.98 micrometers to 12.22 micrometers.
